(19) United States
(12) Patent Application Publication
(10) Pub. No.: US 2017/0106409 A1
(43) Pub. Date: Apr. 20, 2017

(54) MAINTENANCE METHOD OF MASK PLATE

(71) Applicants: BOE TECHNOLOGY GROUP CO., LTD., Beijing (CN); HEFEI BOE OPTOELECTRONICS TECHNOLOGY CO., LTD., Hefei (CN)

(72) Inventors: Yangkun JING, Beijing (CN); Yue SUN, Beijing (CN); Tingting WANG, Beijing (CN); Tingting WANG, Beijing (CN)

(21) Appl. No.: 15/266,066

(22) Filed: Sep. 15, 2016

(30) Foreign Application Priority Data
Oct. 20, 2015 (CN) 201510685461.1

(51) Int. Cl. B05D 5/00; B05D 3/06; G02F 1/13; C23C 26/00

(52) U.S. Cl. CPC B05D 5/005; C23C 26/00; B05D 3/067; G02F 1/1309

(57) ABSTRACT

A maintenance method of a mask plate are provided. The method includes determining determining an abnormality position of the metal coating layer of the mask plate, and determining a coordinate of the abnormality position; coating repairing glue containing a metal material at the abnormality position, so as to flush a plane of the coated glue and a plane of the normal metal coating layer of the mask plate; and curing the repairing glue.

### TECHNICAL FIELD

The present disclosure relates to a maintenance method of a mask plate.

### BACKGROUND

Recently, ODF (One Drop Filling, short for liquid crystal drop filling procedure) has been a representative sophisticated technique in the LCD (Liquid Crystal Display) industry. ODF procedure directly coats sealant after aligning the glass substrates, then drops liquid crystal, performs alignment, attachment under reduced pressure to form a liquid crystal display panel, then uses UV (Ultraviolet Light) to cure the sealant, performs thermal hardening and rearranges the liquid crystal at the same time, and finally cuts the panel. Compared with traditional procedure, ODF procedure not only largely shortens the implanting time of liquid crystal, but also simplifies the manufacturing processes and reduces the dosage of the liquid crystal.

In the ODF procedure, the UV curing process is very significant, and the UV curing process has a very strict requirement on the mask plate. It is required that the metal coating layer on the mask plate cannot be damaged; once the metal coating layer is damaged, light will irradiate on the display region (AA region) of a liquid crystal display panel, which will further cause relevant defective phenomenon, such as afterimage, Mura (a kind of defect of image quality).

In the existing art, if the metal coating layer on the mask plate falls out, it is necessary to replace the mask plate, while the manufacturing cycle of a mask plate is relatively long, this will affect the manufacturing efficiency and increase the manufacturing costs.

### SUMMARY

The embodiments of the present disclosure provide a maintenance method of a mask plate, the mask plate comprises a substrate and a patterned metal coating layer disposed on the substrate, the method comprises: determining an abnormality position of the metal coating layer of the mask plate, and determining a coordinate of the abnormality position; coating repairing glue containing a metal material at the abnormality position, so as to flush a plane of the coated glue and a plane of the normal metal coating layer of the mask plate; and curing the repairing glue.

In some examples, coating repairing glue at the abnormality position comprises: judging an abnormal degree of the abnormality position, if the abnormal degree is larger than a preset value, coating repairing glue at the abnormality position.

In some examples, judging the abnormal degree of the abnormality position, if the abnormal degree is larger than a preset value, coating repairing glue at the abnormality position, comprises: if the abnormality position is located at a non-peripheral region of the metal coating layer, judging a thickness of the metal coating layer of the abnormality position, if a missing thickness of the metal coating layer at the abnormality position with respect to the normal metal coating layer of the mask plate is larger than a preset thickness value, coating repairing glue at the abnormality position; if the abnormality position is located at a peripheral region of the metal coating layer, judging the width of the abnormality position, if the width of the abnormality position is larger than a preset width value, coating repairing glue at the abnormality position.

In some examples, the preset thickness value is 20% of the thickness of the normal metal coating layer, the preset width value is 1/10 of the width of the sealant of a liquid crystal display panel manufactured by using the mask plate.

In some examples, coating repairing glue at the abnormality position comprises: utilizing a marching type dispenser to find the abnormality position, and coating repairing glue at the abnormality position.

In some examples, curing the repairing glue comprises: placing and curing the mask plate coated with repairing glue in an ultraviolet light curing device.

In some examples, determining the abnormality position of the metal coating layer of the mask plate comprises receiving infrared radiation energy of the mask plate, acquiring an infrared thermogram, so as to acquire information of the temperature distribution field of the mask plate; determining the abnormality position of the mask plate according to the information of the temperature distribution field.

In some examples, utilizing an infrared detector and an optical imaging objective lens to receive the infrared radiation energy of the mask plate.

In some examples, determining the abnormality position of the metal coating layer comprises utilizing the mask plate to cure the sealant of the liquid crystal display panel, and utilizing a light indensity sensing device located under the liquid crystal display panel to judge whether the display region of the liquid crystal display panel has light leakage or not, if yes, determining the abnormality position of the mask plate.

In some examples, the method further comprises stop utilizing the mask plate to cure the sealant of the liquid crystal display panel.

In some examples, after determining the abnormality position of the mask plate, before coating repairing glue at the abnormality position, cleaning and blow-drying the mask plate.

In some examples, the metal material in the repairing glue is same as the material of the metal coating layer of the mask plate.

In some examples, the mask plate is a mask plate used for curing the sealant of the liquid crystal display panel.

### BRIEF DESCRIPTION OF THE DRAWINGS

In order to clearly illustrate the technical solutions of the embodiments of the present disclosure, the drawings of the embodiments will be briefly described in the following; it is obvious that the described drawings are only related to some embodiments of the disclosure and thus are not limitative of the present disclosure.

FIG. 1 is a flow schematic diagram of a maintenance method of a mask plate provided by an embodiment of the present disclosure;

FIG. 2 is a structural schematic diagram of a standard mask plate provided by an embodiment of the present disclosure;

FIG. 3a is a structural schematic diagram of an abnormal mask plate provided by an embodiment of the present disclosure;

FIG. 3b is a sectional schematic diagram along AA direction in FIG. 3a;

FIG. 4 is a structural schematic diagram of another abnormal mask plate provided by an embodiment of the present disclosure;

FIG. 5 is a structural schematic diagram of repairing glue provided by an embodiment of the present disclosure; and

FIG. 6 is a structural schematic diagram of a supporting pin provided by an embodiment of the present disclosure.

### DETAILED DESCRIPTION

In order to make objects, technical solutions and advantages of the embodiments of the disclosure apparent, the technical solutions of the embodiment will be described in a clearly and fully understandable way in connection with the drawings related to the embodiments of the disclosure. It is obvious that the described embodiments are just a part but not all of the embodiments of the disclosure. Based on the described embodiments herein, those skilled in the art can obtain other embodiment(s), without any inventive work, which should be within the scope of the disclosure.

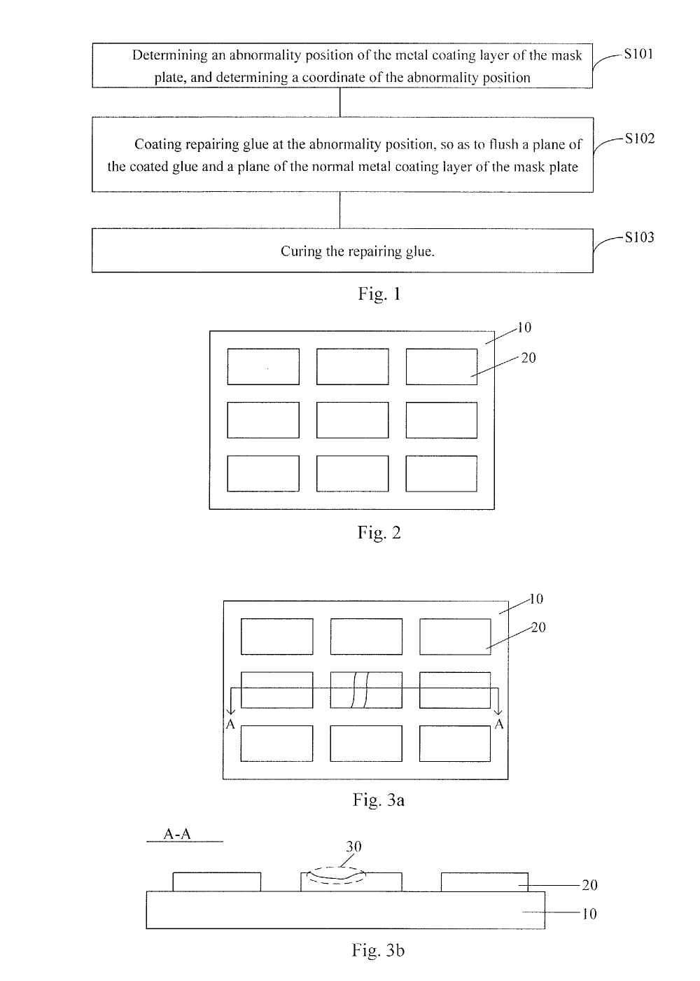

At least one embodiment of the present disclosure provides a maintenance method of a mask plate, as illustrated by FIG. 1, the method comprises the following steps S101 to S103.

S101: determining an abnormality position of a metal coating layer of a mask plate, and determining the coordinate of the abnormality position.

As illustrated by FIG. 2, the mask plate comprises a substrate 10 and a patterned metal coating layer 20 disposed on the substrate. Each patterned metal coating layer 20 corresponds a display region of a liquid crystal display panel.

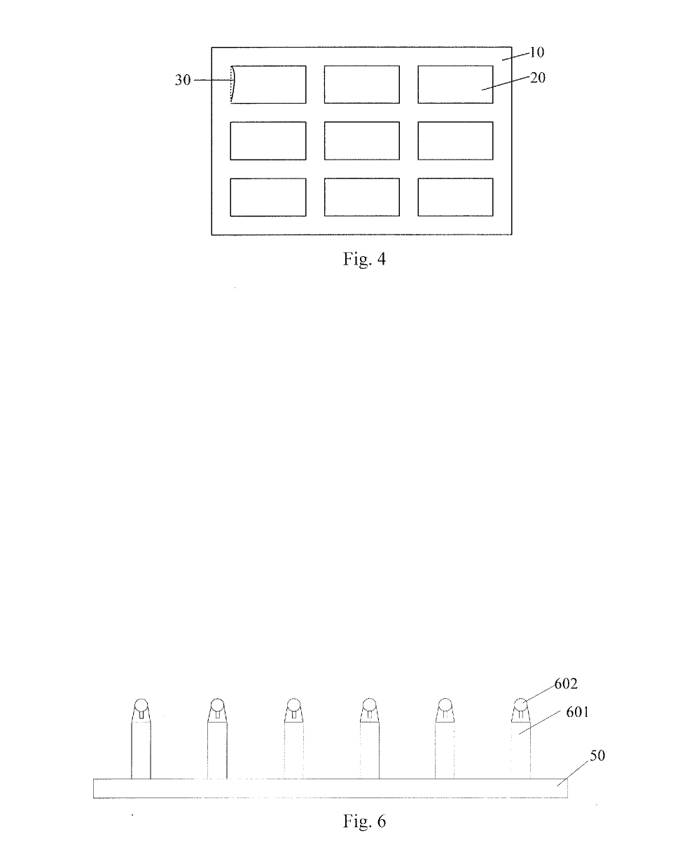

For example, the abnormality of the metal coating layer referred by the embodiment of the present disclosure may be a deficiency of the metal coating layer caused by the detachment of the metal coating layer 20, or may be a deficiency of the metal coating layer caused by technological reasons during the manufacturing process illustrated by FIG. 4. The drawing reference number “30” refers to the missing metal coating layer; FIG. 3b only illustrates a partial deficiency as an example, and the deficiency may be a complete deficiency during the practical using process.

It shall be noted that determining the abnormality position of the metal coating layer of the mask plate may be determined before using the mask plate, or may be determined during the using process of the mask plate, which is not limited herein. Besides, the method for determining the abnormality position of the metal coating layer of the mask plate is not limited herein, as long as the abnormality position of the metal coating layer of the mask plate can be determined, and the coordinate of the abnormality position can be acquired.

S102: coating repairing glue at the abnormality position, so as to flush a plane of the coated glue and a plane of the normal metal coating layer of the mask plate. For example, the repairing glue comprises a metal material.

For example, the normal metal coating layer here may be a metal coating layer with an expected thickness, which can guarantee that the position where the normal metal coating layer is located will not occur light leakage.

Herein, for example, a marching type dispenser can be utilized to coat repairing glue at the abnormality position, certainly, a circle type dispenser, a mobile phone keypad type dispenser, a rotation axis dispenser or other dispensers can be utilized to coat repairing glue at the abnormality position, as long as the abnormality position can be found and the repairing glue can be coated at the abnormality position.

Because a marching type dispenser is relatively conventional in the display device manufacturing field, and can accurately control the position of the glue point, the embodiment of the present disclosure employs a marching type dispenser to coat repairing glue at the abnormality position.

With regard to the metal material in the repairing glue, it can be a metal material with light shielding characteristics, such as aluminum, molybdenum, or argentums. The metal material in the repairing glue can be the same as or different from the metal material of the metal coating layer of the mask plate.

The content of metal material in the repairing glue is within 0.7%-7%, and the specific content is related to the light shielding characteristics of the metal material in the repairing glue. The better the light shielding characteristics of the metal material in the repairing glue are, the less content of the added metal material can be. In the practical using process, the content of the metal material in the repairing glue can be adjusted according to the practical requirements, as long as the abnormality position does not transmit light after being coated with the repairing glue.

Because it is easy to obtain the material of the metal coating layer of the mask plate, for example, the metal material in the repairing glue of the embodiment of the present disclosure is the same as the material of the metal coating layer of the mask plate.

Herein, the specific preparing process of the repairing glue may be: firstly using deionization water (DI Water), and ultra sonic cleaning (USC) to clean tools required during the preparing process such as defoaming mixer, rubber sleeve and medicinal ladle for 10 minutes, after the tools being cleaned, using a dust-free cloth dipped with IPA (isopropanol) to wipe the cleaned tools clean, and using an air gun to blow-dry the tools. After cleaning and blow-drying the tools, using an electronic scale to weigh a required amount of metal material and a required amount of sealant, mixing and placing the weighed sealant and metal material in the rubber sleeve, and then placing the rubber sleeve in a rotation machine of rotation and revolution to conduct stirring and defoaming. The up-and-down flowing movement and eddy generated by the rotation and revolution during the stirring process of the rotation machine can evenly stir the repairing glue.

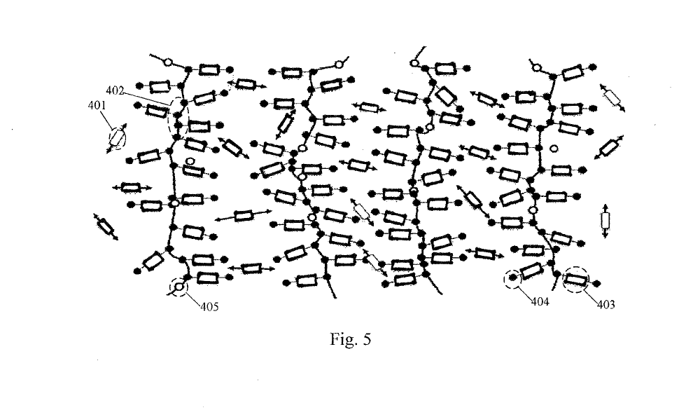

The components of the sealant may comprise a UV hardening resin (propylene series) 401, a UV hardening initiator 402, a thermal hardening resin (epoxy series) 403 and a thermal hardening agent 404. Upon the sealant and the metal material have been stirred evenly, the metal material 405 and the components of the sealant in the repairing glue form a structure as illustrated by FIG. 5.

S103: curing the repairing glue.

Herein, a curing device, for example, an ultraviolet light curing device can be used to perform a curing process to the repairing glue, or a heating furnace or another kind of heating device can be used to perform a curing process to the repairing glue.

Because the energy of ultraviolet light is relatively strong, upon using ultraviolet light to perform a curing process to the repairing glue, on one aspect, the employing time is relatively short, on another aspect, the curing effect is relatively good. Therefore, for example, the embodiment of the present disclosure employs an ultraviolet light curing device to cure the repairing glue. Because the ODF procedure will use an ultraviolet light curing device itself, it may avoid adding the manufacturing costs caused by adding a new device by using the ultraviolet light curing device.

An embodiment of the present disclosure provides a maintenance method of a mask plate, which enlarges the serve life of a mask plate by repairing the abnormal mask plate, and avoids adding the manufacturing costs caused by directly replacing the abnormal mask plate. Besides, an abnormal mask plate can be quickly repaired by using the maintenance method provided by the embodiment of the present disclosure, compared with the existing art which requires a relatively long manufacturing cycle after replacing a mask plate, the embodiment of the present disclosure can improve the manufacturing efficiency.

Optionally, for example, the step S101 can be implemented by the following two methods.

The first method: before using the mask plate, determining an abnormality position of the metal coating layer of the mask plate.

In some examples, utilizing an infrared detector and an optical imaging objective lens to receive infrared radiation energy of the mask plate, acquiring an infrared thermogram, so as to acquire the information of the temperature distribution field of the mask plate; determining an abnormality position of the mask plate according to the information of the temperature distribution field of the mask plate, and determining the coordinate of the abnormality position.

Herein, upon utilizing an infrared detector and an optical imaging objective lens to receive the infrared radiation energy of the detected mask plate, the infrared radiation energy can be reflected on the photo sensitive element of the infrared detector, thus, an infrared thermogram can be acquired, the infrared thermogram corresponds to the heat distribution field of a surface of the mask plate which is provided with a metal coating layer. On this basis, because the infrared thermogram can be converted into a visible thermal image, and different colors on the thermal image represent different temperatures of the surface of the mask plate which is provided with the metal coating layer, and the visible thermal image can be displayed with gray scale or pseudo colors, therefore, the information of the temperature distribution field of the detected mask plate can be acquired according to infrared thermogram.

Based on this, it can be determined that whether the metal coating layer of the mask plate has deficiency or not by preliminarily judging the integrity of the abovementioned infrared thermogram according to the information of the temperature distribution field of the mask plate. Furthermore, the practical area of the metal coating layer of the mask plate can be accurately calculated by calculating the area of the temperature field of the surface of the metal coating layer of the mask plate in the temperature distribution field, and the integrity degree of the surface of the metal coating layer of the mask plate can be determined by comparing the practical area and the standard area. Besides, the information of the temperature distribution field can further embody the inhomogeneity degree of the thickness of the metal coating layer of the mask plate.

Because the infrared detector and the optical imaging objective lens acquires the infrared thermogram of the mask plate by moving along a X axis and a Y axis, i.e., every point on the mask plate scanned by the infrared detector and the optical imaging objective lens corresponds to one point for forming the infrared thermogram, and the information of the temperature distribution field and the points on the infrared thermogram arc one-to-one corresponding, thus, upon finding abnormality according to the information of the temperature distribution field, the abnormality position of the mask plate and the coordinate of the abnormality position can be directly acquired.

It shall be noted that, the infrared detector and optical imaging objective lens can be integrated in an image pick-up device.

The second method: during using process of the mask plate, determining the abnormality position of the metal coating layer of the mask plate.

In some examples, utilizing the mask plate to cure sealant of a liquid crystal display panel, and utilizing a photo indensity sensing device located under the liquid crystal display panel to judge whether there is light leakage in the display region of the liquid crystal display panel or not, if yes, determining the abnormality position of the mask plate and determining the coordinate of the abnormality position.

Herein, upon utilizing a mask plate to cure the sealant of the liquid crystal display panel, a photo intensity sensing device can be disposed between the liquid crystal display panel and the working machine stand, and an ultraviolet light source can be disposed above the mask plate.

For example, the light indensity sensing device can be composed of a nickel hydroxide (Ni(OH)₂) thin film and a titanium dioxide (TiO₂) thin film, upon there is a deficiency of the metal coating layer on the mask plate, the ultraviolet light can go through the deficiency of the metal coating layer and reach the display region (AA region) of the liquid crystal display panel, and further irradiate on the photo intensity sensing device. Upon the ultraviolet light irradiates on the titanium-nickel interlayer of the light indensity sensing device, electrons move from the Ni(OH)₂ thin film to the TiO₂ thin film, and Ni(OH)₂ turns into a nickel oxide in a high valence state (Ni³⁺ and Ni⁴⁺), the transfer of electrons forms an electricity current, and it can be judged whether the mask plate in a running state has abnormality or not by measuring the size of the electricity current. If there is light leakage, firstly judging whether it is a display region or not, if it is a display region, the position of the detachment of the metal coating layer on the mask plate can be acquired according to the position where the electricity current on the photo intensity sensing device changes. Because the mask plate has been aligned with the machine stand after being placed on the machine stand, upon the ultraviolet light irradiates from the upper portion to the lower portion, if the metal coating layer of the mask plate has detachment, the ultraviolet light will go through the mask plate and irradiate on the machine stand, and the coordinate of the position of the detachment of the metal coating layer of the mask plate can be acquired according to physical coordinate of the light on the machine stand.

On this basis, the method further comprises stopping utilizing the abovementioned mask plate to cure the sealant of the liquid crystal panel.

In the embodiment of the present disclosure, a damaged mask plate can be prevented from being used for massive production, so as to avoid loss. Besides, during the detecting process, the coordinate of the abnormality position of the mask plate can be determined, which is convenient for repairing.

Optionally, for example, step S102 may be: judging the abnormal degree of the abnormality position, if the abnormal degree is larger than a preset value, then coating repairing glue at the abnormality position.

Herein, the abnormal degree refers to a missing degree of the metal coating layer, such as the missing area and the missing thickness.

Because a mask plate with low abnormal degree will not affect the cured liquid crystal display panel, it is not necessary to repair all abnormal mask plates, and only the mask plate whose abnormal degree is larger than a preset value needs to be repaired, which can improve the manufacturing efficiency.

For example, judging the abnormal degree of the abnormality position, if the abnormal degree is larger than a preset value, then coating repairing glue at the abnormality position may be:

Upon the abnormality position is located in a non-peripheral region of the metal coating layer, judging the thickness of the metal coating at the abnormality position, with respect to the normal metal coating layer of the mask plate, if the missing thickness of the metal coating layer at the abnormality position is larger than a preset value, then coating repairing glue at the abnormality position.

Herein, for example, the preset value can be 20% of the thickness of the normal metal coating layer.

Upon the abnormality position is located at a peripheral region of the metal coating layer, judging the width of the abnormality position, if the width of the abnormality position is larger than a preset value, coating repairing glue at the abnormality position.

Herein, for example, the preset value can be 1/10 of the width of the sealant of the liquid crystal display panel corresponding to the abnormality position located in the peripheral region.

It shall be noted that, the direction of the abovementioned width is a direction from an edge which has an abnormality position to the opposite edge.

Besides, upon adopting the first method in the step S101 to determine the abnormality position, because a ratio of the practical area and the standard area of the metal coating layer of the mask plate can be acquired during the process, before judging the abnormal degree of the abnormality position, it can be judged that whether the mask plate can be used or not according to the abovementioned ratio, for example, if the abovementioned ratio is larger than 98%, the mask plate may not be repaired, if the abovementioned ratio is less than 98%, judging the abnormal degree of the abnormality position, so as to judge whether it is necessary to coat repairing glue at the abnormality position according to the abnormal degree or not.

Optionally, for example, the step S103 may be: delivering the mask plate which has been repaired by coating repairing glue onto the machine stand of the ultraviolet light curing device through a mechanical hand, and delivering identity information of the mask plate to the ultraviolet light curing device through a PLC (Programmable Logical Controller), the ultraviolet light curing device confirms the time and light indensity for curing the mask plate, after finishing confirmation, finding a mark point on the machine stand through a CCD (Charge Coupled Device) camera to find the mark point on the machine stand, so as to align the mask plate and the machine stand, after the alignment is accomplished, the machine stand vacuum absorbs the mask plate, and the machine stand rises up to a predetermined position to make the mask plate contact the absorption device, at this time, the machine stand releases the vacuum, and absorption device is vacuumized to absorb the mask plate, thus far, the mask plate has been mounted. After that, ultraviolet light can be used to irradiate on the mask plate, so as to cure the repairing glue and cure the metal material in the repairing glue on the substrate of the mask plate, thus far, the repairing has been accomplished.

As illustrated by FIG. 6, the machine stand 50 is provided with a support pin 601, the top of the support pin is provided with a ball 602, which is used to reduce the friction force between the mask plate and the machine stand upon the mask plate moving with respect to the machine stand.

The identity information of the mask plate comprises a mask ID (identity mark) of the mask plate, the mask plates with the same type have the same mask ID, the mask ID can be a number, a two dimensional code or other marks used for distinguishing different types of mask plates.

Based on the abovementioned, between S101 and S102, the method further comprises: cleaning and blow-drying the mask plate, so as to wipe out impurities.

Those skilled in the art shall understand that: all or a part of the steps of the abovementioned method embodiments can be accomplished through hardware related to the program instructions, and the abovementioned program can be stored in a storage medium, upon the program is being executed, executing the steps comprising the abovementioned method embodiments; and the abovementioned storage medium comprises: ROM, RAM, diskette, light disk or different kinds of medium which can store program codes.

The foregoing are merely specific embodiments of the invention, but not limitative to the protection scope of the present disclosure. Therefore, the protection scope of the invention should be defined by the accompanying claims.

The present disclosure claims the benefits of Chinese patent application No. 201510685461.1, which was filed with the SIPO on Oct. 20, 2015 and is fully incorporated herein by reference as part of this application.

What is claimed is:

1. A maintenance method of a mask plate, wherein the mask plate comprises a substrate and a patterned metal coating layer disposed on the substrate, the method comprises:
determining an abnormality position of the metal coating layer of the mask plate, and determining a coordinate of the abnormality position;
coating repairing glue containing a metal material at the abnormality position, so as to flush a plane of the coated glue and a plane of the normal metal coating layer of the mask plate; and
curing the repairing glue.

2. The maintenance method of the mask plate according to claim 1, wherein coating the repairing glue at the abnormality position comprises:
judging an abnormal degree of the abnormality position, if the abnormal degree is larger than a preset value, then coating the repairing glue at the abnormality position.

3. The maintenance method of the mask plate according to claim 2, wherein judging the abnormal degree of the abnormality position, if the abnormal degree is larger than a preset value, then coating the repairing glue at the abnormality position, comprises:
if the abnormality position is located at a non-peripheral region of the metal coating layer, judging a thickness of the metal coating layer at the abnormality position, if a missing thickness of the metal coating layer at the abnormality position with respect to a normal metal coating layer of the mask plate is larger than a preset thickness value, coating the repairing glue at the abnormality position; and
if the abnormality position is located at a peripheral region of the metal coating layer, judging a width of the abnormality position, if the width of the abnormality position is larger than a preset width value, coating the repairing glue at the abnormality position.

4. The maintenance method of the mask plate according to claim 3, wherein the preset thickness value is 20% of a thickness of the normal metal coating layer, the preset width value is 1/10 of a width of sealant of a liquid crystal display panel manufactured by using the mask plate.

5. The maintenance method of the mask plate according to claim 1, wherein coating the repairing glue at the abnormality position, comprises:
utilizing a marching type dispenser to find the abnormality position, and coating the repairing glue at the abnormality position.

6. The maintenance method of the mask plate according to claim 1, wherein curing the repairing glue, comprises:
placing and curing the mask plate coated with the repairing glue in an ultraviolet light curing device.

7. The maintenance method of the mask plate according to claim 1, wherein determining the abnormality position of the metal coating layer of the mask plate comprises:
receiving infrared radiation energy of the mask plate, acquiring an infrared thermogram, so as to acquire information of an temperature distribution field of the mask plate; and
determining the abnormality position of the mask plate according to the information of the temperature distribution field.

8. The maintenance method of the mask plate according to claim 7, wherein utilizing an infrared detector and an optical imaging objective lens to receive the infrared radiation energy of the mask plate.

9. The maintenance method of the mask plate according to claim 1, wherein determining the abnormality position of the metal coating layer comprises:
utilizing the mask plate to cure sealant of a liquid crystal display panel, and utilizing a light indensity sensing device located under the liquid crystal display panel to judge whether the display region of the liquid crystal display panel has light leakage or not, if yes, determining the abnormality position of the mask plate.

10. The maintenance method of the mask plate according to claim 9, further comprising:
stop utilizing the mask plate to cure the sealant of the liquid crystal display panel.

11. The maintenance method of the mask plate according to claim 1, wherein after determining the abnormality position of the mask plate, before coating the repairing glue at the abnormality position, cleaning and blow-drying the mask plate.

12. The maintenance method of the mask plate according to claim 1, wherein the metal material in the repairing glue is the same as a material of the metal coating layer of the mask plate.

13. The maintenance method of the mask plate according to claim 1, wherein the mask plate is a mask plate used for curing sealant of a liquid crystal display panel.
